(19) United States
(12) Patent Application Publication
(10) Pub. No.: US 2025/0046795 A1
(43) Pub. Date: Feb. 6, 2025

(54) ELECTROCHEMICAL DEVICE

(71) Applicant: Panasonic Intellectual Property Management Co., Ltd., Osaka (JP)

(72) Inventors: Nobuhiro SHIMAMURA, Osaka Fu (JP); Kenichi NAGAMITSU, Kyoto Fu (JP)

(73) Assignee: Panasonic Intellectual Property Management Co., Ltd., Osaka (JP)

(21) Appl. No.: 18/695,695

(22) PCT Filed: Sep. 5, 2022
(86) PCT No.: PCT/JP2022/033203

§ 371 Date: Mar. 26, 2024

(30) Foreign Application Priority Data
Sep. 29, 2021 (JP) 2021-159691

(51) Int. Cl. H01M 4/36; H01M 4/02; H01M 4/58; H01M 4/587; H01M 10/0568; H01M 50/417; H01M 50/489

(52) U.S. Cl. CPC H01M 4/366; H01M 4/5825; H01M 4/587; H01M 10/0568; H01M 50/417; H01M 50/489; H01M 2004/021; H01M 2004/027; H01M 2300/0025

(57) ABSTRACT

An electrochemical device includes a positive electrode, a negative electrode, a separator and a lithium ion-conductive electrolyte. The positive electrode includes a positive electrode active material into which anions are reversibly doped. The negative electrode includes a negative electrode current collector, and a negative electrode mixture layer supported on the negative electrode current collector, the negative electrode mixture layer includes a negative electrode active material into which lithium ions are reversibly doped, and the negative electrode active material includes hardly graphitized carbon. The negative electrode mixture layer has a specific surface area of 10 m²/g or more, and 70 m²/g or less. The separator includes an olefin-based resin.

### TECHNICAL FIELD

The present invention relates to an electrochemical device.

### BACKGROUND ART

Recently, electrochemical devices based on a combination of power storage principles of lithium-ion secondary batteries and electric double layer capacitors have attracted attention. Such electrochemical devices usually use a polarizable electrode for the positive electrode and a non-polarizable electrode for the negative electrode. As a result, electrochemical devices are expected to have both the high energy density of lithium-ion secondary batteries and the high output characteristics of electric double-layer capacitors.

Patent Literature 1 has proposed a power storage device in which an electrolyte, and a power storage device element obtained by stacking a positive electrode and a negative electrode via a separator are housed in an exterior body, the power storage device including: a positive electrode terminal and a negative electrode terminal that are electrically connected to the positive electrode and the negative electrode constituting the power storage device, and protrude outward from the exterior body, wherein the power storage device element is provided with an insulating first fixing member configured to fix the positive electrode, the negative electrode, and the separator constituting the power storage device element, and cancel the fixation at a temperature between 90° C. or more, and 160° C. or less.

### CITATION LIST

### Patent Literature

PTL 1: JP 2014-123699A

### SUMMARY OF INVENTION

### Technical Problem

As separators of electrochemical devices, typically, cellulose-based non-woven fabrics (hereinafter also referred to as cellulose-based separators) are used. Cellulose-based separators are inexpensive but tends to contain water, easily causing degradation of the negative electrode due to the water. The internal resistance of the electrochemical devices tends to increase due to the degradation of the negative electrode.

### Solution to Problem

An aspect of the present invention is directed to an electrochemical device including: a positive electrode; a negative electrode; a separator; and a lithium ion-conductive electrolyte, wherein the positive electrode includes a positive electrode active material into which anions are reversibly doped, the negative electrode includes a negative electrode current collector, and a negative electrode mixture layer supported on the negative electrode current collector, the negative electrode mixture layer includes a negative electrode active material into which lithium ions are reversibly doped, the negative electrode active material includes hardly graphitized carbon, the negative electrode mixture layer has a specific surface area of 10 m²/g or more, and 70 m²/g or less, and the separator includes an olefin-based resin.

### Advantageous Effects of Invention

According to the present invention, an increase in the internal resistance of an electrochemical device is suppressed.

### DESCRIPTION OF EMBODIMENTS

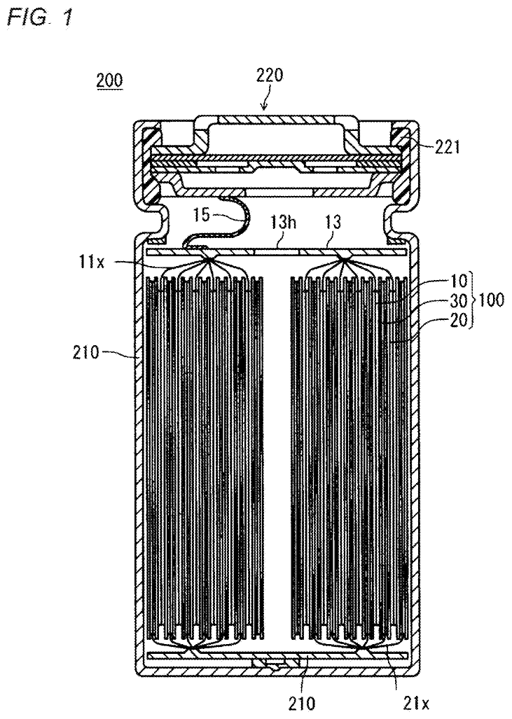

FIG. 1 is a vertical cross-sectional view illustrating a configuration of an electrochemical device according to an embodiment of the present invention.

### DESCRIPTION OF EMBODIMENTS

An electrochemical device according to an embodiment of the present invention includes a positive electrode, a negative electrode, a separator and a lithium ion-conductive electrolyte. The positive electrode includes a positive electrode active material into which anions are reversibly doped. The negative electrode includes a negative electrode current collector, and a negative electrode mixture layer supported on the negative electrode current collector. The negative electrode mixture layer includes a negative electrode active material into which lithium ions are reversibly doped, and the negative electrode active material includes hardly graphitized carbon. The specific surface area of the negative electrode mixture layer is 10 m²/g or more, and 70 m²/g or less. The separator includes an olefin-based resin. Hereinafter, a separator including an olefin-based resin is also referred to as an olefin-based separator.

Since an olefin-based separator has a lower amount of water than a cellulose-based separator, degradation of the negative electrode due to water in the separator is suppressed, and an increase in the internal resistance of electrochemical devices due to degradation of the negative electrode is suppressed. Also, compared to a cellulose-based separator, an olefin-based separator has excellent stability with respect to an electrolyte containing lithium ions (or metallic lithium adhered to the surface of the negative electrode in the pre-doping process) and is less likely to degrade. Accordingly, by using an olefin-based separator, the low internal resistance is maintained over a prolonged period of time. As a result, the electrochemical device has improved reliability.

When the negative electrode active material contains hardly graphitized carbon and the negative electrode mixture layer has a specific surface area of 10 m²/g or more, the resistance of the negative electrode is significantly reduced, thereby significantly reducing the internal resistance of the electrochemical device. Also, in this case, the reactivity of the negative electrode increases and the above-described deterioration of the negative electrode easily progresses, so that it is possible to obtain a remarkable effect of suppressing the deterioration of the negative electrode by using an olefin-based separator. However, if the specific surface area of the negative electrode mixture layer is larger than 70 m²/g, there may be cases where the reactivity of the negative electrode is very high and the above-described degradation of the negative electrode cannot be suppressed.

In view of suppressing the degradation of the negative electrode, the specific surface area of the negative electrode mixture layer is preferably 10 m²/g or more, and 50 m²/g or less.

The hardly graphitized carbon experiences a Faraday reaction in which lithium ions are reversibly absorbed and released, and capacitance is generated. Doping of lithium ions into the negative electrode active material includes at least a phenomenon in which lithium ions are absorbed into the negative electrode active material, and is a concept that may also include adsorption of lithium ions to the negative electrode active material, chemical interaction between the negative electrode active material and lithium ions, and the like.

The negative electrode potential is, for example, 0.2 V or less on a lithium basis (vs. Li/Li ⁺). The above-described negative electrode potential is a negative electrode potential (25° C.) at the completion of later-described pre-doping (or charging). Lithium ions are pre-doped in the negative electrode mixture layer. With this, the potential of the negative electrode decreases, and the potential difference (i.e., voltage) between the positive electrode and the negative electrode increases, resulting in an improvement in the energy density of the electrochemical device. The amount of lithium to be pre-doped is set in such a manner that the negative electrode potential in the electrolyte after the completion of the pre-doping is 0.2 V or less with respect to metallic lithium. The amount of lithium to be pre-doped need only be, for example, 50% to 95% of the maximum amount of lithium that can be absorbed into the negative electrode mixture layer.

The specific surface area of the negative electrode mixture layer is a BET specific surface area obtained using a measurement apparatus in accordance with JIS Z8830 (for example, TriStar II 3020 of Shimadzu Corporation). Specifically, the electrochemical device is disassembled and the negative electrode is extracted. A half cell is assembled using the negative electrode as the working electrode and a Li metal foil as the counter electrode, and Li in the negative electrode is dedoped until the negative electrode potential reaches 1.5V. Then, the negative electrode in which Li is dedoped is washed with dimethyl carbonate (DMC) and is dried. Thereafter, the negative electrode mixture layer is peeled off from the negative electrode current collector, and a sample of the negative electrode mixture layer of about 0.5 g is collected.

Then, the collected sample is heated at 150° C. for 12 hours under a reduced pressure of 95 kPa or less, and then nitrogen gas is adsorbed to the sample of a known mass to obtain adsorption isotherms in a relative pressure range of 0 to 1. The surface area of the sample is calculated based on the amount of monolayer adsorption of gas obtained from the adsorption isotherms. Here, the specific surface area is obtained from the following BET formula using the BET one-point method (relative pressure of 0.3).

P/V(P0−P)=(1/VmC)+{(C−1)/VmC}(P/P0) (1)

S=kVm (2)
P0: Saturation vapor pressure
P: Adsorption equilibrium pressure
V: Amount of adsorption at adsorption equilibrium pressure P
Vm: Amount of monolayer adsorption
C: Parameter relating to adsorption heat and the like
S: Specific surface area
k Unimolecular area at nitrogen 0.162 nm²

The surface layer portion of the negative electrode mixture layer may have a first layer containing lithium carbonate as a constituent component of the film. The first layer is mainly formed on the surface of the negative electrode active material. The larger the specific surface area of the negative electrode mixture layer is, the more likely the negative electrode is to degrade, but the degradation of the negative electrode is significantly suppressed when the first layer is formed. Note however that a cellulose-based separator tends to degrade more severely in environments where lithium carbonate is generated on the surface layer portion of the negative electrode mixture layer. On the other hand, an olefin-based separator is less likely to degrade even in environments where lithium carbonate is generated on the surface layer portion of the negative electrode mixture layer, and a favorable first layer is formed, thus making it possible to maximize the above-described effect of the first layer.

The surface layer portion of the negative electrode may have a second layer containing a solid electrolyte as a constituent component of the film. The second layer has a different composition from the first layer, and the second layer is distinguishable from the first layer. In electrochemical devices using lithium ions, a solid electrolyte interface film (i.e., SEI film) is formed on the negative electrode mixture layer during charging and discharging. The second layer may be formed as an SEI film. The SEI film plays an important role in charge and discharge reactions, but if the SEI film is formed excessively thick, the negative electrode will severely degrade. In contrast, the first layer containing lithium carbonate acts to promote the formation of a favorable SEI film, and to maintain the SEI film in good conditions when charging and discharging are repeatedly performed. Accordingly, by forming the first layer on the surface layer portion of the negative electrode mixture layer, the degradation of the negative electrode can be significantly suppressed even when the specific surface area of the negative electrode mixture layer is increased to suppress an increase in low-temperature DCR.

When the film has a first layer and a second layer, at least part of the second layer covers at least part of the surface of the negative electrode active material via the first layer. In other words, at least part of the first layer is covered by the second layer. The first layer is interposed between the surface of the negative electrode active material and the second layer, and serves as the foundation layer of the second layer. By the first layer serving as the foundation layer, the second layer is formed as an SEI film in good conditions.

Also, the second layer can contain lithium carbonate. If the second layer contains lithium carbonate, the content of lithium carbonate contained in the second layer is less than the content of lithium carbonate contained in the first layer. Using the first layer containing more lithium carbonate as a foundation layer is a necessary condition for the second layer to be formed as an SEI film in good conditions.

The first layer is formed on the surface layer portion of the negative electrode mixture layer before assembling the electrochemical device. In an electrochemical device assembled using that negative electrode, by subsequent charging and discharging, a second layer (SEI film) of a homogeneous and appropriate thickness is formed on the surface of the negative electrode active material. The SEI film is formed, for example, by the reaction between the electrolyte and the negative electrode in the electrochemical device. Since the electrolyte can pass through not only the second layer but also the first layer, the entire surface layer portion including the first layer and the second layer may be referred to as the SEI film, but in the present specification, the second layer is referred to as the SEI film and is distinguished from the first layer, for the sake of convenience.

The presence of a region containing lithium carbonate, such as the first layer, can be recognized, for example, by analyzing the surface layer portion through X-ray photoelectron spectroscopy (XPS). Note however that the analysis method is not limited to XPS.

The thickness of the first layer need only be, for example, 1 nm or more, and the thickness of the first layer is preferably 5 nm or more if more long-term effect is expected, and is preferably 10 nm or more if more reliable effect is expected. Note however that, if the thickness of the first layer exceeds 50 nm, the first layer itself may become a resistive component. Therefore, the thickness of the first layer may be 50 nm or less, or 30 nm or less. For example, the thickness of the first layer is 1 nm to 50 nm.

The thickness of the second layer is preferably, for example, 1 nm or more, or 3 nm or more, and it is sufficient when the thickness of the second layer is 5 nm or more. Note however that, if the thickness of the second layer exceeds 20 nm, the second layer itself may become a resistive component. Therefore, the thickness of the second layer maybe 20 nm or less, or 10 nm or less.

The ratio A/B of the thickness A of the first layer to the thickness B of the second layer is preferably 1 or less in view of reducing the initial low-temperature DCR. At this time, the thickness of the second layer is preferably 20 nm or less, and may be 10 nm or less. Note however that, in view of forming a second layer with good condition, it is desirable that the A/B ratio be 0.1 or more, and the A/B ratio may be, for example, 0.2 or more.

The thicknesses of the first layer and the second layer are measured at a plurality of positions (at least 5 positions) on the negative electrode mixture layer by analyzing the surface layer portion of the negative electrode mixture layer. Then, it is sufficient to define an average of the thicknesses of the first layer or the second layer measured at the plurality of positions as the thickness of the first layer or the second layer. Note that the negative electrode mixture layer used for the measurement sample may be peeled off from the negative electrode current collector. In this case, it is sufficient to analyze the film formed on the surface of the negative electrode active material that constituted the vicinity of the surface layer portion of the negative electrode mixture layer. Specifically, from a region of the negative electrode mixture layer disposed on the surface opposite to the surface that was bonded to the negative electrode current collector, the negative electrode active material covered with the film need only be collected and used for analysis.

XPS analysis of the surface layer portion of the negative electrode mixture layer is performed in such a manner that, for example, the film formed on the surface layer portion or the surface of the negative electrode active material is irradiated with an argon beam in the chamber of an X-ray photoelectron spectrometer, and changes in each spectrum attributed to C1s is electrons, O1s electrons, and the like with respect to irradiation time are observed and recorded. At this time, in view of avoiding analytical errors, the spectrum of the outermost surface of the surface layer portion may be ignored. The thickness of the region in which a peak attributed to lithium carbonate are stably observed corresponds to the thickness of the first layer.

In the case of a negative electrode removed from the inside of an electrochemical device that has been completed and has undergone predetermined aging or at least one charging and discharging cycle, the surface layer portion of the negative electrode mixture layer has an SEI film (that is, the second layer) containing a solid electrolyte. The thickness of the region in which the peak attributed to the bonding of the compound contained in the SEI film are stably observed corresponds to the thickness of the SEI film (that is, the thickness of the second layer).

As the compound contained in the SEI film, a compound containing an element that can serve as a label of the second layer is selected. As the element that can serve as a label of the second layer, it is sufficient to select, for example, an element (e.g., F) that is contained in the electrolyte but is not contained in the first layer. For example, LiF can be selected as the compound containing an element that can serve as a label of the second layer.

If the second layer contains LiF, a F1s peak attributed to a LiF bond is observed by measuring the second layer with X-ray photoelectron spectroscopy. In this case, the thickness of the region in which a peak attributed to a LiF bond is stably observed corresponds to the thickness of the second layer.

On the other hand, typically, the first layer does not contain LiF, and no substantial F1s peak attributed to a LiF bond is measured even by measuring the first layer with X-ray photoelectron spectroscopy. Accordingly, the thickness of the region in which a peak attributed to a LiF bond is not stably observed may be defined as the thickness of the first layer.

An O1s peak attributed to lithium carbonate can also be observed in the SEI film. Note however that the SEI film formed in the electrochemical device has a composition different from that of the first layer formed in advance, and thus it is possible to distinguish the two. For example, in the XPS analysis of the SEI film, an F1s peak attributed to a LiF bond is observed, but no substantial F1s peak attributed to a LiF bond is observed in the first layer. Also, the amount of lithium carbonate contained in the SEI film is low. Note that, as a Li1s peak, a peak originating from compounds such as ROCO₂Li and ROLi, for example, can be detected.

When analyzing the first layer by XPS, a first O1s peak attributed to a C═O bond as well as a second O1s peak attributed to a Li—O bond maybe observed. The region of the film present in the vicinity of the surface of the negative electrode active material may contain a small amount of LiOH or Li₂O.

Specifically, when analyzing the first layer constituting the surface layer portion of the negative electrode mixture layer in the depth direction, a first region in which the first peak (O1s attributed to a C═O bond) and the second peak (O1s attributed to a Li—O bond) are observed and the intensity of the first peak is greater than the intensity of the second peak, and a second region in which the first peak and the second peak are observed and the intensity of the second peak is greater than the intensity of the first peak may be observed in the order of increasing distance from the outermost surface of the surface layer portion. Furthermore, there may be a third region that is located closer to the outermost surface of the surface layer portion than the first region and in which the first peak is observed but the second peak is not observed. The third region is more likely to be observed when a region containing lithium carbonate has a large thickness.

Note that the magnitude of the intensity of a peak can be determined on the basis of the height of the peak from the baseline.

In the center of the first layer in the thickness direction, typically, a C1s peak attributed to a C—C bond is substantially not observed, or a C1s peak, if observed, has a peak intensity smaller than or equal to one half of the intensity of the peak attributed to a C—O bond.

The following will describe a method of forming the first layer containing lithium carbonate on the surface layer portion of the negative electrode mixture layer. The process of forming the first layer may be performed by, for example, a vapor phase method, a coating method, a transfer method, or the like.

The vapor phase method includes chemical vapor deposition, physical vapor deposition, sputtering, and the like. For example, it is sufficient to use a vacuum deposition apparatus to attach lithium carbonate to the surface of the negative electrode mixture layer. The pressure in the chamber of the apparatus during deposition need only be, for example, 10⁻² to 10⁻⁵ Pa, the temperature of the lithium carbonate evaporation source need only be 400 to 600° C., and the temperature of the negative electrode mixture layer need only be −20 to 80° C.

As the coating method, the surface of the negative electrode is coated with a solution or a dispersion liquid containing lithium carbonate using, for example, a micro gravure coater, and is dried, thereby forming the first layer. The content of lithium carbonate in the solution or dispersion liquid is, for example, 0.3 to 2% by mass, and when the solution is used, the concentration thereof need only be less than or equal to the solubility (for example, 0.9 to 1.3% by mass for room-temperature aqueous solution).

Furthermore, by performing a process of forming a second layer containing a solid electrolyte so that it covers at least part of the first layer, the negative electrode can be obtained. The surface layer portion of the obtained negative electrode mixture layer has a first layer and a second layer. The second layer is formed so that at least a portion thereof covers at least a portion (preferably the entire) of the surface of the negative electrode active material via the first layer (i.e., using the first layer as a foundation layer).

Because the process of forming the second layer is performed in a state in which the negative electrode mixture layer is in contact with the electrolyte, the process of forming the second layer may also serve as at least part of a process of pre-doping lithium ions into the negative electrode mixture layer. Examples of the lithium ion source for the pre-doping may include metallic lithium.

Metallic lithium may be attached to the surface of the negative electrode mixture layer. Note that it is also possible to form the first layer containing lithium carbonate having a thickness of, for example, 1 nm or more and 50 nm or less, by exposing the negative electrode having the negative electrode mixture layer to which metallic lithium is attached to a carbon dioxide atmosphere.

The process of attaching metallic lithium to the surface of the negative electrode mixture layer may be performed by, for example, a vapor phase method, a transfer method, or the like. The vapor phase method includes chemical vapor deposition, physical vapor deposition, sputtering, and the like. For example, it is sufficient to use a vacuum deposition apparatus to form membranous metallic lithium on the surface of the negative electrode mixture layer. The pressure in the chamber of the apparatus during deposition need only be, for example, 10⁻² to 10⁻⁵ Pa, the temperature of the lithium evaporation source need only be 400 to 600° C., and the temperature of the negative electrode mixture layer need only be −20 to 80° C.

It is desirable that the carbon dioxide atmosphere be a dry atmosphere without containing any water, and just have to have a dew point of, for example, −40° C. or less, or −50° C. or less. The carbon dioxide atmosphere may contain gas other than carbon dioxide, and the molar fraction of carbon dioxide is preferably 80% or more, and more preferably 95% or more. Oxidized gas is preferably not contained, and the molar fraction of oxygen need only be 0.1% or less.

To form a thicker first layer, it is efficient if the partial pressure of carbon dioxide is greater than, for example, 0.5 atmospheric pressure (5.05×10⁴ Pa), and may be greater than 1 atmospheric pressure (1.01×10⁵ Pa).

The temperature of the negative electrode to be exposed to the carbon dioxide atmosphere just has to be in the range of 15° C. to 120° C. The higher the temperature is, the thicker the first layer becomes.

By changing time for which the negative electrode is exposed to the carbon dioxide atmosphere, it is possible to easily control the thickness of the first layer. The exposure time need only be, for example, 12 hours or more and less than 10 days.

The process of forming the first layer is preferably performed before the electrode assembly is formed, but this does not preclude the case where the process is performed after the formation of the electrode assembly. That is, a configuration is also possible in which a positive electrode is prepared, a negative electrode including a negative electrode mixture layer to which metallic lithium is attached is prepared, an electrode assembly is formed with a separator interposed between the positive electrode and the negative electrode, and the electrode assembly is exposed to a carbon dioxide atmosphere to form a first layer on the surface layer portion of the negative electrode mixture layer.

Note that, for example, by subsequently bringing the negative electrode mixture layer with the electrolyte, the pre-doping process of lithium ions into the negative electrode mixture layer is further progressed, and by leaving them as is for a predetermined time, the pre-doping process is complete. Such a process may be the process of forming a second layer so that it covers at least part of the first layer. For example, by performing at least one charging and discharging cycle on the electrochemical device, it is possible to form the second layer on the negative electrode mixture layer, and complete the pre-doping of lithium ions into the negative electrode. It is also possible to complete the pre-doping of lithium ions into the negative electrode, by, for example, applying a predetermined charging voltage (for example, 3.4 to 4.0 V) between the terminals of the positive electrode and the negative electrode for a predetermined time (for example, 1 to 75 hours).

### (Olefin-Based Separator)

Commonly used cellulose-based separators have many functional groups that easily react with lithium ions, such as OH groups, and also contain a relatively large amount of water, and thus are easily to be subjected to damage due to side reactions. Also, due to the reaction of metallic lithium with the separator, the amount of lithium to be pre-doped in the negative electrode may be reduced. Note that the main reason why cellulose-based separators are commonly used is that they have excellent electrolyte permeability and pre-doping proceed easily.

When performing pre-doping of lithium ions in the state of a wound body obtained by winding the positive electrode and the negative electrode with a separator interposed between the positive electrode and the negative electrode, it is difficult to use an olefin separator because the lithium ions eluted from the metallic lithium fed for pre-doping are difficult to be diffused over the entire wound body. So, when metallic lithium for pre-doping is directly dipped into the electrolyte, it is essential to use a cellulose-based separator.

In contrast, in the electrochemical device according to the present embodiment, an olefin-based separator is used. Since an olefin-based separator has low reactivity with metallic lithium, the deterioration of the separator is suppressed and the reliability of the electrochemical device is improved. In addition, an olefin-based separator has high strength and even a thin olefin-based separator can have a sufficiently high strength. Therefore, by tightly winding the positive electrode and the negative electrode, it is possible to use a wound body with high surface pressure, resulting in an improvement in the performance of electrochemical devices, such as capacity.

An olefin-based resin contained in the separator preferably includes at least one selected from the group consisting of polypropylene (PP) and polyethylene (PE). The PP separator and the PE separator have high strength and are stable against an electrolyte containing lithium ions, and thus can be preferably used in the electrochemical device in which the first layer and the second layer are formed on the surface layer portion of the negative electrode mixture layer.

On the other hand, an olefin-based separator has a higher air permeability resistance than a cellulose-based separator, and has a low passage rate of lithium ions via the separator. Such a large air permeability resistance of an olefin-based separator does not pose any problem in typical charging and discharging of electrochemical devices, but in the process of pre-doping lithium ions, pre-doping may take time due to the low passage rate of lithium ions. In this regard, in the pre-doping process, it is preferable to adopt a method in which lithium ions are not supplied to the negative electrode via the separator. For example, as described below, execution of pre-doping is possible without requiring a long period of time, by bringing the negative electrode with metallic lithium attached to the entire surface of the negative electrode mixture layer in advance, into contact with the electrolyte, and performing the pre-doping.

The air permeability resistance of the separator is preferably 70 sec/100 mL or more, and 500 sec/100 mL or less. When the air permeability resistance is in this range, it is possible to realize both a reduction in the internal resistance of the electrochemical device and an improvement in the reliability. More preferably, the air permeability resistance of the separator may be 70 sec/100 mL or more, and 300 sec/100 mL or less, and may be more preferably 70 sec/100 mL or more, and 230 sec/100 mL or less (or 180 sec/100 mL or more, and 230 sec/100 mL or less).

Here, the air permeability resistance is an index indicating the time (in seconds) required for a given volume (100 mL) of air to permeate, per unit area of the separator, when a given pressure difference is applied between two sides of the separator, and is measured based on JIS P8117:2009 by the Gurley tester method in which the separator area (permeable portion) is set to 6.42 cm² and the weight of the inner cylinder is set to 567 g.

The thickness of the separator is preferably 12 μm or more, and 30 m or less, in view of that lithium ions can easily permeate and the separator has a sufficient strength.

FIG. 1 schematically shows a configuration of an electrochemical device 200 according to an embodiment of the present invention. The electrochemical device 200 includes electrode assemblies 100, a non-aqueous electrolyte (not shown), a bottomed cell case 210 that is made of a metal and houses the electrode assemblies 100 and the non-aqueous electrolyte, and a sealing plate 220 that seals an opening in the cell case 210. Each electrode assembly 100 is configured as a columnar wound body obtained by winding a band-shaped positive electrode 10 and a band-shaped negative electrode 20 with a separator 30 interposed between the positive electrode 10 and the negative electrode 20. The sealing plate 220 has a gasket 221 attached to the peripheral edge thereof, and the open end of the cell case 210 is fitted to the gasket 221, so that the inside of the cell case 210 is sealed. A positive electrode current collecting plate 13 having a through hole 13h μm the center thereof is welded to positive electrode-core material exposed portions 11x. A tab lead 15 has one end connected to the positive electrode current collecting plate 13, and the other end connected to the inner surface of the sealing plate 220. Accordingly, the sealing plate 220 functions as an external positive electrode terminal. On the other hand, a negative electrode current collecting plate 23 is welded to negative electrode-core material exposed portions 21x. The negative electrode current collecting plate 23 is directly welded to a welding member provided on the inner bottom surface of the cell case 210. Thus, the cell case 210 functions as an external negative electrode terminal.

The electrochemical device is not limited to a wound-type electrochemical device as shown in FIG. 1. For example, the electrochemical device may be a laminate-type electrochemical device. That is, the electrode assembly may also be configured as a laminated body obtained by laminating sheet-shaped positive and negative electrodes one above the other with the separator interposed between the positive and negative electrodes.

Hereinafter, the constituent components of the electrochemical device according to the embodiment of the present invention will be described in further detail.

### (Negative Electrode)

The negative electrode is provided with a negative electrode current collector, and a negative electrode mixture layer supported on the negative electrode current collector. The negative electrode mixture layer includes a negative electrode active material into which lithium ions are reversibly doped, and the negative electrode active material includes hardly graphitized carbon (that is, hard carbon). The thickness of the negative electrode mixture layer is, for example, 10 to 300 μm per one side of the negative electrode current collector.

A sheet-shaped metal material is used for the negative electrode current collector. The sheet-shaped metal material need only be metal foil, porous metal, etched metal, or the like. The metal material may be copper, a copper alloy, nickel, stainless steel, or the like.

The negative electrode current collecting plate is a metal plate in a substantially disk shape. Examples of the material of the negative electrode current collecting plate include copper, a copper alloy, nickel, and stainless steel. The material of the negative electrode current collecting plate may be the same as the material of the negative electrode current collector.

The hardly graphitized carbon may have an interplanar spacing of planes (002) (i.e., interplanar spacing between carbon layers) d002 of 3.8 Å or more, as measured by the X-ray diffraction method. It is desirable that the theoretical capacity of the hardly graphitized carbon be, for example, 150 mAh/g or more. By using such hardly graphitized carbon, it is easier to obtain a negative electrode that has a small low-temperature DCR and small expansion and contraction during charging and discharging. The hardly graphitized carbon accounts for preferably 50% or more by mass of the negative electrode active material, more preferably 80% or more, and furthermore preferably 95% or more. Also, the hardly graphitized carbon accounts for preferably 40% or more by mass of the negative electrode mixture layer, more preferably 70% or more, and furthermore preferably 90% or more.

As the negative electrode active material, such hardly graphitized carbon and a material other than hardly graphitized carbon may be used in parallel. Examples of the material other than hardly graphitized carbon that can be used as the negative electrode active material include easily graphitized carbon (soft carbon), graphite (such as natural graphite and artificial graphite), lithium titanium oxide (such as spinel-type lithium titanium oxide), silicon oxide, a silicon alloy, tin oxide, and a tin alloy.

From the viewpoint of high fillability of the negative electrode with the negative electrode active material and easy controllability of side reactions with the electrolyte, the average particle diameter of the negative electrode active material (particularly, hardly graphitized carbon) is preferably 1 μm to 20 μm, and is more preferably 2 μm to 15 μm.

Note that in the present specification, the average particle diameter means the median diameter (D50) on a volumetric basis in a particle size distribution obtained by laser diffraction particle size distribution measurement.

The negative electrode mixture layer contains the negative electrode active material as an essential component, and contains a conductive agent, a binding agent, a thickening agent, and the like, as optional components. The conductive agent includes carbon black, carbon fiber, and the like. Examples of the carbon black include acetylene black (AB) and ketjen black (KB). The binding material includes a fluorine resin, an acrylic resin, a rubber material, and the like. The thickening agent includes a cellulose derivative and the like.

The negative electrode mixture layer may include a negative electrode active material and a conductive agent. In this case, the specific surface area of the negative electrode mixture layer can reflect the specific surface areas of the negative electrode active material and the conductive agent. For example, if a conductive agent (for example, KB) having a large specific surface area is used, the specific surface area of the negative electrode mixture layer may be adjusted by changing the amount of conductive agent to be added.

The negative electrode mixture layer is formed by, for example, mixing the negative electrode active material and a conductive agent or the like with a dispersion medium to prepare a negative electrode mixture slurry, applying the negative electrode mixture slurry to the negative electrode current collector, and then drying it.

Lithium ions are pre-doped in the negative electrode mixture layer. With this, the potential of the negative electrode decreases, and the potential difference (i.e., voltage) between the positive electrode and the negative electrode increases, resulting in an improvement in the energy density of the electrochemical device. The amount of lithium to be pre-doped need only be, for example, 50% to 95% of the maximum amount of lithium that can be absorbed into the negative electrode mixture layer.

### (Positive Electrode)

The positive electrode includes a positive electrode active material into which anions are reversibly doped. The positive electrode active material is, for example, a carbon material, a conductive polymer, and the like. The positive electrode may be provided with a positive electrode mixture layer containing a positive electrode active material, and a positive electrode current collector supporting the positive electrode mixture layer. The thickness of the positive electrode mixture layer is, for example, 10 to 300 μm per one side of the positive electrode current collector.

A sheet-shaped metal material is used for the positive electrode current collector. The sheet-shaped metal material need only be metal foil, porous metal, etched metal, or the like. The metal material may be aluminum, an aluminum alloy, nickel, titanium, or the like.

The positive electrode current collecting plate is a metal plate in a substantially disk shape. A through hole serving as a pathway for a non-aqueous electrolyte is preferably formed in the center of the positive electrode current collecting plate. Examples of the material of the positive electrode current collecting plate include aluminum, an aluminum alloy, titanium, and stainless steel. The material of the positive electrode current collecting plate may be the same as the material of the positive electrode current collector.

As a carbon material used as the positive electrode active material, a porous carbon material is preferably used, and, for example, activated carbon and a carbon material (for example, hardly graphitized carbon) exemplified as the negative electrode active material are preferable. Examples of a raw material of the activated carbon include wood, palm shells, coal, pitch, and phenolic resin. The activated carbon is preferably carbon subjected to activation process.

The average particle diameter of the carbon material is not particularly limited, but is preferably 20 μm or less, and more preferably 3 μm to 15 μm.

The specific surface area of the positive electrode mixture layer typically reflects the specific surface area of the positive electrode active material. The specific surface area of the positive electrode mixture layer may be, for example, 600 m²/g or more and 4000 m²/g or less, and may preferably be 800 m²/g or more and 3000 m²/g or less. The specific surface area of the positive electrode mixture layer is a BET specific surface area obtained using a measurement apparatus in accordance with JIS Z8830 (for example, TriStar II 3020 of Shimadzu Corporation). Specifically, the electrochemical device is disassembled and the positive electrode is extracted. Then, the positive electrode is washed with DMC and dried. Subsequently, the positive electrode mixture layer is peeled off from the positive electrode current collector, and a sample of the positive electrode mixture layer of about 0.5 g is collected. Then, the specific surface area of the collected sample is obtained using the same method as the above-described method of measuring the specific surface area of the negative electrode mixture layer.

The activated carbon accounts for preferably 50% or more by mass of the positive electrode active material, more preferably 80% or more, and furthermore preferably 95% or more. Also, the activated carbon accounts for preferably 40% or more by mass of the positive electrode mixture layer, more preferably 70% or more, and furthermore preferably 90% or more.

The positive electrode mixture layer contains the positive electrode active material as an essential component, and contains a conductive agent, a binding agent, a thickening agent, and the like, as optional components. The conductive agent includes carbon black, carbon fiber, and the like. The binding material includes a fluorine resin, an acrylic resin, a rubber material, and the like. The thickening agent includes a cellulose derivative and the like.

The positive electrode mixture layer is formed by, for example, mixing the positive electrode active material and a conductive agent or the like, with a dispersion medium to prepare a positive electrode mixture slurry, applying the positive electrode mixture slurry to the positive electrode current collector, and then drying it.

The conductive polymer used as the positive electrode active material is preferably a π-conjugated polymer. As the π-conjugated polymer, for example, polypyrrole, polythiophene, polyfuran, polyaniline, polythiophenevinylene, polypyridine, or their derivatives can be used. These may be used alone or in combination of two or more. The weight average molecular weight of the conductive polymer is, for example, 1000 to 100000. Note that derivatives of the π-conjugated polymer mean polymers having a basic skeleton of the π-conjugated polymer such as polypyrrole, polythiophene, polyfuran, polyaniline, polythiophenevinylene, and polypyridine. For example, polythiophene derivatives include poly(3,4-ethylenedioxythiophene) (PEDOT), and the like.

The conductive polymer is formed by, for example, immersing a positive electrode current collector with a carbon layer into a reaction solution containing monomers of a raw material for the conductive polymer, and electropolymerizing the raw material monomers in the presence of the positive electrode current collector. In the electropolymerization, it is sufficient that the positive electrode current collector and the counter electrode are immersed into the reaction solution containing the raw material monomers, and a current is caused to flow between the positive electrode current collector serving as an anode, and the counter electrode. The conductive polymer may also be formed by a method other than electropolymerization. For example, the conductive polymer may be formed by chemical polymerization of the raw material monomers. In the chemical polymerization, it is sufficient that the raw monomers are polymerized by an oxidizing agent or the like in the presence of the positive electrode current collector.

The raw material monomers used in the electropolymerization or chemical polymerization may be any polymerizable compound as long as it can generate a conductive polymer by polymerization. The raw material monomers may include oligomers. For example, aniline, pyrrole, thiophene, furan, thiophenevinylene, pyridine, or their derivatives are used as the raw material monomers. These may be used alone or in combination of two or more. Among them, aniline is easily grown on the surface of the carbon layer by electropolymerization.

The electropolymerization or chemical polymerization can be performed using a reaction solution containing anions (dopants). Doping the π-electron conjugated polymers with dopants achieves excellent conductive properties. Dopants include sulfate ions, nitrate ions, phosphate ions, borate ions, benzenesulfonate ions, naphthalenesulfonate ions, toluenesulfonate ions, methanesulfonate ions, perchlorate ions, tetrafluoroborate ions, hexafluorophosphate ions, fluorosulfate ions, and the like. The dopants may also be polymer ions. Examples of polymer ions include ions of polyvinyl sulfonate, polystyrene sulfonate, polyaryl sulfonate, polyacryl sulfonate, polymethacryl sulfonate, poly(2-acrylamido-2-methylpropanesulfonate), polyisoprene sulfonate, polyacrylic acid, and the like.

### (Separator)

The separator includes an olefin-based resin. The olefin-based resin is a resin that contains an olefin unit as a main component. The olefin-based resin contains, for example, 50% or more by mass of the olefin unit, and furthermore 70% or more. An olefin unit refers to a monomer unit derived from olefin (alkene) such as ethylene, propylene, and butene. Here, the divalent group (diyl group) formed by polymerization of a monomer is referred to as the “unit” of that monomer. At least part of the olefin may be derivatives thereof. The olefin-based resin may be a homopolymer or a copolymer synthesized from a plurality of types of olefins. Part of the hydrogen atoms of the olefin may be substituted with halogen atoms. Examples of the olefin-based resin may include polyethylene (PE), polypropylene (PP), polymethylpentene (PMP), chlorinated polyethylene (CPE), ethylene-vinyl acetate copolymer (EVA), and ethylene-ethyl acrylate copolymer (EEA).

The separator containing an olefin-based resin may be, for example, a microporous membrane, woven or non-woven fabric made of polyolefin. The thickness of the separator is, for example, 8 to 40 μm, is preferably 12 to 30 μm, and more preferably 14 to 25 μm or 16 to 25 μm. Among microporous membranes, woven fabrics, and non-woven fabrics, microporous membranes, which are non-fibrous porous films, are preferable in view of their particularly high strength and suitability for film thinning.

### (Electrolyte)

The electrolyte has lithium ion conductivity, and contains lithium salt and a solvent in which lithium salt is dissolved. Anions of lithium salt reversibly repeat doping to and dedoping from the positive electrode. Lithium ions derived from lithium salt are reversibly absorbed and released to the negative electrode.

Examples of lithium salt include LiClO₄, LiBF₄, LiPF₆, LiAlCl₄, LiSbF₆, LiSCN, LiCF₃SO₃, LiFSO₃, LiCF₃CO₂, LiAsF₆, LiB₁₀Cl₁₀, LiCl, LiBr, LiI, LiBCl₄, LiN(SO₂F)₂, and LiN(SO₂CF₃)₂. These may be used alone or in combination of two or more. Lithium salt is preferably salt having fluorine-containing anions in view of its abilities to obtain electrolyte with high dissociation and low viscosity, and improve the voltage withstanding characteristics of the electrochemical device.

The electrolyte preferably includes an imide system electrolyte. The imide system electrolyte contains imide system anions as anions of the lithium salt. The imide system anions may be anions containing fluorine and sulfur, and may particularly preferably be lithium bis(fluorosulfonyl)imide, that is, LiN(SO₂F)₂(LiFSI). For example, 80% or more by mass of the lithium salt may be LiFSI.

It is conceivable that LiFSI has the effect of reducing degradation of the positive electrode active material and the negative electrode active material. Among salts with fluorine-containing anions, FSI anions have excellent stability, and thus are considered to be less likely to produce side products and contribute to smooth charging and discharging without damaging the surface of the active material. The SEI film formed of LiFSI on the surface layer portion of the negative electrode mixture layer contains a large amount of lithium fluoride and a small percentage of lithium carbonate. With this, a stable film (second layer), which contains lithium fluoride as a main component, can be formed so as to cover the second layer, which contains lithium carbonate as a main component.

The concentration of the lithium salt in the non-aqueous electrolyte in a charging state (at a charging rate (SOC) of 90 to 100%) is, for example, 0.2 to 5 mol/L.

As the solvent, the following can be used. That is, cyclic carbonates such as ethylene carbonate, propylene carbonate, and butylene carbonate; chain carbonates such as dimethyl carbonate, diethyl carbonate, and ethyl methyl carbonate; aliphatic carboxylic acid ester such as methyl formate, methyl acetate, methyl propionate, ethyl propionate; lactones such as γ-butyrolactone and γ-valerolactone; chain ether such as 1,2-dimethoxyethane (DME), 1,2-diethoxyethane (DEE), and ethoxymethoxyethane (EME); cyclic ether such as tetrahydrofuran, and 2-methyltetrahydrofuran; dimethyl sulfoxide; 1,3-dioxolane; formamide; acetamide; dimethylformamide; dioxolane; acetonitnile; propionitrile; nitromethane; ethyl monoglyme; trimethoxymethane; sulfolane; methylsulfolane; 1,3-propanesartone; and the like can be used. These may be used alone or in combination of two or more.

Various additives may be added to the electrolyte as needed. For example, unsaturated carbonate such as vinylene carbonate, vinylethylene carbonate, or divinylethylene carbonate may be added as an additive that forms a lithium ion conductive film on the surface of the negative electrode.

### WORKING EXAMPLES

The following will describe the present invention more specifically based on working examples, but the present invention is not limited to the working examples.

### <<Electrochemical Devices A1 to A5, and B1 to B10>>

### (Positive Electrode Manufacturing)

Aluminum foil (a positive electrode current collector) with a thickness of 30 μm was prepared. On the other hand, a positive electrode mixture slurry was prepared by dispersing 88 parts by mass of activated carbon (average particle diameter of 5.5 μm), which is a positive electrode active material, 6 parts by mass of acetylene black (AB), which is a conductive agent, 4 parts by mass of carboxymethyl cellulose (CMC), which is a thickening agent, and 2 parts by mass of polytetrafluoroethylene (PTFE), which is the binding material, in water. The obtained positive electrode mixture slurry was applied to both sides of the aluminum foil, and the applied film was dried and rolled to form a positive electrode mixture layer, thereby obtaining a positive electrode. A 10 mm wide exposed portion of the positive electrode current collector was formed at an end of the positive electrode current collector in the longitudinal direction.

### (Negative Electrode Manufacturing)

Copper foil (negative electrode current collector) with a thickness of 10 μm was prepared. On the other hand, a negative electrode mixture slurry was prepared by dispersing total 90 parts by mass of a negative electrode active material and a conductive agent, 4 part by mass of carboxymethyl cellulose (CMC), which is a thickening agent, and 6 parts by mass of styrene butadiene rubber (SBR), which is a binding agent, in water. The obtained negative electrode mixture slurry was applied to both sides of the copper foil, and the applied film was dried and rolled to form a negative electrode mixture layer, thereby obtaining a negative electrode. As the negative electrode active material, hardly graphitized carbon (average particle diameter of 5 μm) or graphite (average particle diameter of 5 μm) was used. As the conductive agent, ketjen black (KB) was used. The mixture ratio of the negative electrode active material and the conductive agent was set to the value shown in Table 1. The specific surface area of the negative electrode mixture layer was adjusted to the value shown in Table 1 by changing the mixture ratio of the negative electrode active material and the conductive agent.

Then, a thin film of metallic lithium for pre-doping was formed on the entire surface of the negative electrode mixture layer by vacuum vapor deposition. The amount of lithium to be pre-doped was set so that the negative electrode potential with respect to the metallic lithium in the non-aqueous electrolyte after completion of the pre-doping was 0.2 V or less.

Then, the chamber of the apparatus was purged with carbon dioxide to create a carbon dioxide atmosphere, and a first film containing lithium carbonate was formed on the surface layer portion of the negative electrode mixture layer. The dew-point temperature of the carbon dioxide atmosphere was −40° C., the molar fraction of carbon dioxide was 100%, and the pressure in the chamber was 1 atmospheric pressure (1.01×10⁵ Pa). The temperature of the negative electrode exposed to the carbon dioxide atmosphere of 1 atmospheric pressure was 25° C. The period of time for which the negative electrode was exposed to the carbon dioxide atmosphere was set to 22 hours. The first layer does not substantially include F (or LiF).

### (Electrode Assembly Manufacturing)

As the separator, a microporous membrane separator (thickness of 25 μm) of a single layer structure made of polypropylene (PP), which serves as an olefin-based separator, or a non-woven fabric separator (thickness of 25 μm) made of cellulose, which serves as a cellulose-based separator, was used. The air permeability resistance of the separator was the value shown in Table 1.

Each electrode assembly was formed by winding a positive electrode and a negative electrode into a columnar shape via a separator. At that time, the positive electrode-core material exposed portions protruded from one end faces of the wound bodies, and the negative electrode-core material exposed portions protruded from the other end faces of the electrode assemblies. Disk-shaped positive electrode current collecting plate and negative electrode current collecting plate were respectively welded to the positive electrode-core material exposed portions and the negative electrode-core material exposed portions.

### (Preparation of Non-Aqueous Electrolyte)

LiFSI, serving as lithium salt, was dissolved in a mixed solvent of ethylene carbonate (EC), ethyl methyl carbonate (EMC), and diethyl carbonate (DEC) (in a volume ratio of 3:5:2) to prepare anon-aqueous electrolyte. The concentration of LiFSI in the non-aqueous electrolyte was 1.2 mol/L.

### (Assembling of Electrochemical Device)

The electrode assemblies were housed in a bottomed cell case having an opening, a tab lead connected to the positive electrode current collecting plate was connected to the inner surface of the sealing plate, and the negative electrode current collecting plate was welded to the inner bottom of the cell case. After the non-aqueous electrolyte was placed in the cell case, the opening of the cell case was closed by the sealing plate, and an electrochemical device as shown in FIG. 1 was assembled. In Table 1, A1 to A5 are electrochemical devices according to the embodiment, and B1 to B10 are electrochemical devices according to a comparative example.

Then, aging was performed at 60° C. while applying a charging voltage of 3.8 V between the terminals of the positive electrode and the negative electrode, and pre-doping of lithium ions into the negative electrode was completed.

The electrochemical devices according to the embodiment and the comparative examples were evaluated as follows.

### [Evaluation 1: Measurement of Internal Resistance of Electrochemical Device]

Each electrochemical device immediately after the aging was subjected to a constant-current charge at a current density of 2 mA/cm² per positive electrode area under the environment of −30° C. until the voltage reached 3.8 V, and then was maintained for 10 minutes in the state in which the voltage of 3.8 V was being applied. Then, the electrochemical device was subjected to a constant-current discharge at a current density of 2 mA/cm² per positive electrode area under the environment of −30° C. until the voltage reached 2.2 V.

Using the discharge curve (where the vertical axis is a discharge voltage, and the horizontal axis is discharge time) obtained from the above-described discharge, the first-order approximate straight line in the range of 0.5 seconds to 2 seconds after the start of discharge in the discharge curve was obtained, and the voltage VS of the intercept of the approximate straight line was obtained. The value obtained by subtracting the voltage VS from the voltage V0 at the start of discharge (0 seconds after the start of discharge) (V0−VS) was calculated as ΔV. Using ΔV(V) and the current value Id (current density per positive electrode area of 2 mA/cm²×the positive electrode area) during the discharge, the internal resistance (DCR) R1 (Ω) of the electrochemical device was obtained from the following expression (A). This was defined as an initial DCR

Internal resistance R1=ΔV/Id (A)

### [Evaluation 2: Reliability Evaluation of Electrochemical Device]

Then, each electrochemical device was maintained in a state in which a constant voltage of 3.8 V was applied to the electrochemical device under the environment of 85° C., for a long period of time. After 1000 hours, the electrochemical device was taken out and placed in the environment of −30° C. The internal resistance (DCR) R2 (Ω) of the electrochemical device was obtained using the same method as in Evaluation 1. The ratio R2/R1 of R2 to R1 was obtained as a change ratio (degradation ratio). The smaller the change ratio is, the more the increase in internal resistance was suppressed and the higher the reliability was.

The evaluation results are given in Table 1. Note that in Table 1 and Table 2, HC denotes hardly graphitized carbon, and the internal resistance R1 indicates an index when the internal resistance R1 of the electrochemical device A2 is set as 100. In Table 1, the change ratio (R2/R1) indicates an index when the change ratio (R2/R1) of the electrochemical device A2 is set as 100.

TABLE 1

| | | Mixture ratio of negative | | Specific | | | | | |
|---|---|---|---|---|---|---|---|---|---|
| | | electrode active material | | surface | | | | | |
| | | and conductive agent | | area of | | | | Internal | |
| | | (parts by mass) | | negative | Separator | | | resistance | Change |
| | Negative | Negative | | electrode | | | Air | R1 | ratio |
| | electrode | electrode | | mixture | | | permeability | (initial | R2/R1 |
| Electrochemical | active | active | Conductive | layer | | Thickness | resistance | DCR) | (reliability) |
| device | material | material | agent | (m²/g) | Material | (μm) | (sec/100 mL) | (index) | (index) |
| B1 | Graphite | 89 | 1 | 5 | Cellulose-based | 25 | 6 | 400 | 130 |
| B2 | Graphite | 89 | 1 | 5 | Olefin-based | 25 | 200 | 380 | 120 |
| B3 | HC | 89 | 1 | 5 | Cellulose-based | 25 | 6 | 280 | 85 |
| B4 | HC | 89 | 1 | 5 | Olefin-based | 25 | 200 | 285 | 70 |
| B5 | HC | 88 | 2 | 10 | Cellulose-based | 25 | 6 | 150 | 105 |
| A1 | HC | 88 | 2 | 10 | Olefin-based | 25 | 200 | 155 | 90 |
| B6 | Graphite | 85 | 5 | 25 | Cellulose-based | 25 | 6 | 180 | 190 |
| B7 | Graphite | 85 | 5 | 25 | Olefin-based | 25 | 200 | 175 | 180 |
| B8 | HC | 85 | 5 | 25 | Cellulose-based | 25 | 6 | 100 | 120 |
| A2 | HC | 85 | 5 | 25 | Olefin-based | 25 | 200 | 100 | 100 |
| A3 | HC | 75 | 15 | 50 | Olefin-based | 25 | 200 | 70 | 115 |
| B9 | HC | 70 | 20 | 60 | Cellulose-based | 25 | 6 | 55 | 200 |
| A4 | HC | 70 | 20 | 60 | Olefin-based | 25 | 200 | 55 | 120 |
| A5 | HC | 65 | 25 | 70 | Olefin-based | 25 | 200 | 50 | 130 |
| B10 | HC | 60 | 30 | 90 | Olefin-based | 25 | 200 | 40 | 170 |

In the electrochemical devices B1 to B10, an increase in the initial DCR and/or a decrease in reliability were acknowledged. In the electrochemical devices A1 to A5, a small initial DCR and favorable reliability were obtained. Both the initial DCR and the change ratio could be suppressed in cases where the negative electrode active material was HC, rather than cases where the negative electrode active material was graphite (A2, B7).

When the negative electrode active material was HC and the separator was a cellulose-based separator, the change ratio was low when the specific surface area of the negative electrode mixture layer was less than 10 m²/g, but the change ratio was increased when the specific surface area of the negative electrode mixture layer was 10 m²/g or more (B3, B5, B8, and B9).

On the other hand, when the negative electrode active material was HC and the separator was an olefin-based separator, the change ratio was low when the specific surface area of the negative electrode mixture layer was less than 10 m²/g, and the change ratio was low even when the specific surface area of the negative electrode mixture layer was 10 m²/g or more(B4, A1-A5).

That is to say, the reliabilities of the electrochemical devices in which the specific surface area of the negative electrode mixture layer was 10 m²/g or more, and the negative electrode active material was HC were significantly increased by exchanging the cellulose-based separator with the olefin-based separator (exchanging B5 with A1, B8 with A2, and B9 with A4).

### <<Electrochemical Devices A6 to A10>>

Electrochemical devices were manufactured in the same manner as in the electrochemical device A4, except for using, as an olefin-based separator, a microporous membrane separator made of polypropylene (PP) having a thickness and an air permeability resistance whose values are shown in Table 2. A6 to A10 in Table 2 indicate the electrochemical devices of the present embodiment. The evaluation results of the electrochemical devices A6 to A10, together with the electrochemical device A4, are shown in Table 2.

TABLE 2

| | | Mixture ratio of | | | | | | |
|---|---|---|---|---|---|---|---|---|
| | | negative electrode | | Specific | | | | |
| | | active material and | | surface | | | | |
| | | conductive agent | | area of | | | | Internal |
| | | (parts by mass) | | negative | Separator | | | resistance |
| | Negative | Negative | | electrode | | | Air | R1 |
| | electrode | electrode | | mixture | | | permeability | (initial |
| Electrochemical | active | active | Conductive | layer | | Thickness | resistance | DCR) |
| device | material | material | agent | (m²/g) | Material | (μm) | (sec/100 mL) | (index) |
| A6 | HC | 85 | 5 | 60 | Olefin-based | 45 | 600 | 160 |
| A7 | HC | 85 | 5 | 60 | Olefin-based | 40 | 500 | 140 |
| A8 | HC | 85 | 5 | 60 | Olefin-based | 30 | 300 | 90 |
| A4 | HC | 85 | 5 | 60 | Olefin-based | 25 | 200 | 55 |
| A9 | HC | 85 | 5 | 60 | Olefin-based | 16 | 100 | 35 |
| A10 | HC | 85 | 5 | 60 | Olefin-based | 15 | 70 | 30 |

All the electrochemical devices had low initial DCR, and exhibited favorable reliabilities. The initial DCR was largely decreased in the electrochemical devices A4 and A7 to A10.

Also, the following evaluations were conducted on the negative electrodes of the electrochemical devices A1 to A5.

### [Evaluation 3: XPS Analysis of the Surface Layer Portion of the Negative Electrode Mixture Layer]

The surface layer portion of each negative electrode mixture layer exposed to a carbon dioxide atmosphere was analyzed by XPS for a C1s spectrum, an O1s spectrum, and an Li1s spectrum. X-ray photoelectron spectrometer (product name: Model 5600, manufactured by ULVAC Phi Inc.) was used for the analysis. The measurement conditions are given below:
X-ray source: A1-mono (1486.6 eV) 14 kV/200 W
Measurement diameter: 800 Vm(p
Photoelectron takeoff angle: 45°
Etching conditions: Acceleration voltage of 3 kV, etching rate: about 3.1 nm/min (SiO₂ equivalent), raster area 3.1 mm×3.4 mm.

As analysis results of the C1s spectrum, the O1s spectrum, and the Liis spectrum, the thickness of the first layer was acknowledged as about 18 nm. Specifically, peaks such as a C—C bond and the like, which were estimated as impurity carbon, were observed on the outermost surface, but the peaks were rapidly decreased at the vicinity of a position of the first layer at the depth of 1 to 2 nm. On the other hand, a first peak attributed to a C═O bond was observed from the outermost surface of the surface layer portion to the depth of 18 nm. From the vicinity of the depth of 18 nm, a peak attributed to a Li—O bond was observed. Furthermore, the presence of Li was steadily observed from the outermost surface of the surface layer portion to the depth of 18 nm. From the vicinity of the depth of 18 nm, a peak attributed to a Li—O bond was observed.

The surface layer portion of the negative electrode mixture layer of the negative electrode taken out from each of the electrochemical devices was analyzed by XPS in a manner similar to the above-described manner, and it was acknowledged that a SEI film (second layer), which has a different composition from the first layer and is distinguishable from the first layer, of the thickness of 10 nm was formed. Also, a peak attributed to a LiF was observed.

### INDUSTRIAL APPLICABILITY

The electrochemical device according to the present invention is appropriate for use in vehicle installation, for example.

### REFERENCE SIGNS LIST

100: Electrode assembly
10: Positive electrode
11X: Positive-electrode core material exposed portion
13: Positive electrode current collecting plate
15: Tab lead
20: Negative electrode
21X: Negative electrode-core material exposed portion
23 Negative electrode current collecting plate
30: Separator
200: Electrochemical device
210: Cell case
220: Sealing plate
221: Gasket

1. An electrochemical device comprising: a positive electrode; a negative electrode; a separator; and a lithium ion-conductive electrolyte,
wherein the positive electrode includes a positive electrode active material into which anions are reversibly doped,
the negative electrode includes a negative electrode current collector, and a negative electrode mixture layer supported on the negative electrode current collector,
the negative electrode mixture layer includes a negative electrode active material into which lithium ions are reversibly doped,
the negative electrode active material includes hardly graphitized carbon,
the negative electrode mixture layer has a specific surface area of 10 m²/g or more, and 70 m²/g or less, and
the separator includes an olefin-based resin.

2. The electrochemical device according to claim 1,
wherein the negative electrode has a potential of 0.2 V or less on a lithium basis.

3. The electrochemical device according to claim 1,
wherein the specific surface area of the negative electrode mixture layer is 10 m²/g or more, and 50 m²/g or less.

4. The electrochemical device according to claim 1,
wherein the separator has an air permeability resistance of 70 sec/100 mL or more, and 500 sec/100 mL or less.

5. The electrochemical device according to claim 4,
wherein the air permeability resistance of the separator is 70 sec/100 mL or more, and 300 sec/100 mL or less.

6. The electrochemical device according to claim 1,
wherein the lithium ion-conductive electrolyte contains lithium bis(fluorosulfonyl) imide: LiN(SO₂F)₂.

7. The electrochemical device according to claim 1,
wherein a surface layer portion of the negative electrode mixture layer includes a first layer containing lithium carbonate.

8. The electrochemical device according to claim 7,
wherein the surface layer portion of the negative electrode mixture layer includes a second layer containing a solid electrolyte, and
at least part of the second layer covers at least part of a surface of the negative electrode mixture layer via the first layer.

9. The electrochemical device according to claim 8,
wherein the second layer contains lithium carbonate, and
a content of lithium carbonate contained in the second layer is less than a content of lithium carbonate contained in the first layer.

10. The electrochemical device according to claim 7,
wherein the first layer has a thickness of 1 nm or more, and 50 nm or less.

11. The electrochemical device according to claim 8,
wherein, when the first layer is measured by X-ray photoelectron spectroscopy, no substantial F1s peak attributed to a LiF bond is observed, and
when the second layer is measured by X-ray photoelectron spectroscopy, a substantial F1s peak attributed to a LiF bond is observed.
